(19) United States
(12) Patent Application Publication
(10) Pub. No.: US 2006/0117653 A1
(43) Pub. Date: Jun. 8, 2006

(54) Seed mat

(75) Inventor: Fred Werth, Santa Fe, NM (US)

Correspondence Address: GREENLEE WINNER AND SULLIVAN P C, 4875 PEARL EAST CIRCLE, SUITE 200, BOULDER, CO, 80301, US

(73) Assignee: Tall Grass Restorations, Inc., Santa Fe, NM (US)

(21) Appl. No.: 11/238,743

(22) Filed: Sep. 29, 2005

Related U.S. Application Data
(60) Provisional application No. 60/614,357, filed on Sep. 29, 2004.

(51) Int. Cl. A01C 1/04

(52) U.S. Cl. 47/56

(57) ABSTRACT

Dried compositions in the form of sheets or rolled sheets which contain viable seeds for application to land surfaces for generation of vegetation on the land surface. The dried composition provides the benefits of use of hydromulch techniques in landscaping and revegetation applications, but does not require the on-site use of hydromulch spraying equipment and avoids excess labor requirements for after-spray clean-up. The dried compositions are mulch compositions containing viable seed and, preferably containing fertilizer, which are formed into sheets which may contain one or more layers or coated layers. Exemplary mulch layers are formed from a mixture of paper and clay which may be provided as magazine stock. The fibrous material can be dried plant material such as hay, straw, dried grass or wood fiber. The seed mat may be formed by adding the fibrous material to a hydromulch containing viable seeds and forming a layer by one or more spraying applications which is dried to form sheet. The seed mat may also be formed by one or more spray applications of a hydromulch containing viable seed onto a layer of fibrous material which is then dried to form a sheet. Seed mats may also be formed by application of a mulch slurry to a fibrous material followed by drying.

### CROSS-REFERENCE TO RELATED APPLICATIONS

This application takes priority under 37 C.F.R. 119(e) to provisional patent application Ser. No. 60/614,357, filed Sep. 29, 2004, which is incorporated by reference in its entirety herein.

### BACKGROUND OF THE INVENTION

A variety of seed mats are known in the art. Seed mats are reported, for example, in U.S. Pat. Nos. 4,190,981; 4,357,780; 4,414,776; 4,584,790, and 5,274,951.

U.S. Pat. No. 4,190,981 relates to a laminated mat for growing vegetation that has a base sheet of biodegradable web material which is permeable to water. Seeds and dried compressed peat particles are joined to this base sheet using an adhesive binder. A fibrous, porous veil covers and protects the seed layer. Water can pass through the upper protective layer to the bed of peat particles and seeds. The biodegradable veil is reported to expand to retain the wet, expanded peat particles and the seeds. The base layer is exemplified as light tissue paper, the adhesive binder as a water-based rubber adhesive and the veil is described as “unwoven fabric having cotton-like texture.”

U.S. Pat. Nos. 4,357,780 and 4,414,776 relate to a fibrous web for planting seeds. The fibrous web “consists essentially of a mat of randomly oriented, unmodified, natural straw-like cellulosic fibers, viable seeds, water soluble adhesive and fertilizer.” A mat of randomly oriented natural cellulosic fibers is sprayed with water-soluble adhesive and seeds and fertilizer are deposited on the adhesive-coated mat. A method of making the fibrous web which employs a conveyor belt is reported.

U.S. Pat. No. 4,584,790 relates to seed mats having a mulch layer of chopped straw sprayed with glue over which fertilizer is distributed. A sheet of paper is applied to the mulch layer and seeds are distributed in a glue layer on the paper. A final layer of paper is applied over the glue/seed layer. A method for manufacture of the seed mat employing a conveyor is reported. In use the upper paper layer is placed in contact with the ground.

U.S. Pat. No. 5,274,951 relates to a seed delivery device which comprises a sheet of biodegradable material, particularly a paper mache sheet provided with a plurality of apertures to provide a “waffle-like” configuration. Seed are bonded to one side of the sheet between the apertures. Nutrients are impregnated into the sheet. The bonded layer of seed is placed in contact with the ground and the seeds grow up through the sheet.

U.S. Pat. No. 4,297,810 relates to a sprayable hydromulch which is sprayed onto ground to be revegetated. The mulch contains hay which is cut or milled to give a mixture of fibers of diverse sizes and shredded and/or chopped paper, preferably magazine stock. Seeds and fertilizer and preferably a binding agent are added to the sprayable mulch. The use of the sprayable mulch is reported to allow application of seed and materials needed for its growth in one operation. In an example, 100 lbs. of seed, 350 lbs. of fertilizer, and 750 lbs. of mulch are combined with 2,500 gallons of water for spraying on 1 acre of rolling land.

U.S. Pat. No. 4,716,679 relates to a pre-grown lawn turf product. A base layer of loose or palletized straw is deposited on an impervious surface and a top layer is formed thereon by applying a slurry of grass seed and water with comminuted straw. The seed is reported to germinate to form turf with roots of the grass bunched into a matt against the impervious surface. It is further reported that the turf can be readily rolled up as needed. With this product, turf is grown and then transported to the site of application

U.S. Pat. Nos. 6,029,395 and 6,293,045 relate to biodegradable mulch mats comprising an “open celled composite of granules and fibers in a binder matrix prepared from a foam precursor”. The binder is reported to serve to hold the fibers and granules in an expanded structure formed by foam. Slurries of fibers, granules, binder and surfactant are gas entrained to provide a foam which is applied to soil around seedlings. The foam is reported to dry to form a mulch mat which suppresses weeds. Useful binders are reported to be biodegradable polymers including polysaccharides such as starch, glycosides, vegetable gums, protein such as gelatin and milk solids, synthetic polymers such as polyvinylacetate, waxes and cross-linkable oils. The mulch mats are said to be effective in suppressing growth of plants from seed from beneath the mat. The mat is also reported to support germination and growth of seeds growing in a seed germination growth medium located on the top surface of the mat. Seeds are not included in the mulch mat applied to soil.

U.S. Pat. No. 6,096,373 relates to a sprayable composition for forming an outdoor protective layer which comprises a bulking/setting material, a water-soluble polymer and water and optionally clay, fibrous material, a foam producing agent and a hardening retarder. Bulking/settling materials include gypsum, fly ash, lime, cement, pot ash, silicates, cement kiln dust, Portland stone, dolomite, marble, and chalk. The composition is reported to form a protective, water-resistant covering layer over material upon which it is sprayed. The composition is reported to be useful when applied to soil for planting applications for which applications seed and fertilizer can be added to the sprayable composition. It is stated that “(f)or hydroseeding application, seed and fertilizer can be added to the slurry to provide a plant covering to retain soil after the covering biodegrades.”

While a number of seed mat configurations have been reported there remains a need in the art for seed mats that are low cost, easy-to-manufacture, biodegradable, that provide increased protection from the wind, that exhibit increased resistance to wash out and that exhibit high germination efficiency.

### SUMMARY OF THE INVENTION

This invention relates to dried compositions in the form of sheets or rolled sheets which contain viable seeds. The dried compositions are useful for application to land surfaces for generation of vegetation on the land surface. The sheets or rolled sheets have long shelf-life (if protected from moisture) of three months or longer and preferably up to one year. The sheets can be cut during application or pre-cut into desirable sizes to facilitate application.

The seed mat is a dried composition in the form of a sheet (or rolled sheets) that contains one or more layers wherein at least one layer contains fibrous material and at least one layer contains mulch and viable seeds. The seed mat may be formed of a single layer containing fibrous material, mulch and seed, with optional, but preferred fertilizer. The seed mat may be formed of two or more layers wherein one layer (the top layer) is fibrous material and the remaining layers contain one or more of mulch and seed. Any layer containing mulch or seed can also contain fertilizer and optionally contains other additives that are beneficial to germination and/or growth of the seed.

Preferred mulch comprises clay. In a specific embodiment, mulch comprises paper and clay which can be provided in the form of magazine stock and optionally added clay. Mulch may contain fibrous material such as wood shavings, flax, or other plant materials, such as leaves, stalks, etc. The mulch may be a mulch composition that is suitable as a hydromulch (when water is added). Clay may be added to any mulch composition employed in the forming the seed mat to increase the mechanical strength of the resultant seed mat.

Most generally, the dried compositions are mulch compositions containing viable seed and, preferably containing fertilizer which are formed into sheets which may contain one or more layers or coated layers. In specific embodiments, fibrous materials are combined with mulch, seeds and various components beneficial for plant growth to form a dried composition comprising one or more layers or coated layers. The dried composition has sufficient mechanical strength to form a sheet which can be packaged and transported to the site where it is to be installed. In specific embodiments, the mat is formed by application of one or more layers of a hydromulch composition (containing seeds) to a layer of fibrous material and subsequent drying of the layers to form the mulch layer. In specific embodiments, the one or more mulch layers are formed by spray application. In specific embodiments, the mulch layer is formed by one or more applications of a mulch slurry or paste to the fibrous layer and subsequent drying of applied layers to form the mulch layer. In specific embodiments, the mulch or precursor hydromulch is formed from a mixture of paper and clay which may be provided as magazine stock. Additional clay may be added to a magazine stock mulch to provide for desired mechanical strength for formation of dried sheets for packaging and transportation.

The invention also relates to methods for establishing vegetation in a desired location employing the dried composition of this invention, methods for making the dried compositions of this invention. Kits containing one or more pre-cut or rolled sheets of the dried composition wherein the viable seed can be grass seed, flower seed or the like, which may be employed to establish flowers or grass in a residential or other landscaping application. Such kits may also include installation and/or after care instructions, as well as growth-stimulating or growth maintenance compositions.

### BRIEF DESCRIPTION OF THE FIGURES

Not Applicable

### DETAILED DESCRIPTION OF THE INVENTION

Spray application of hydromulch including seeds and or hydroseeding methods have been successfully employed in landscaping and revegetation applications and is particularly useful for establishing vegetation, such as grass, over large surface areas. However, spray hydromulching techniques require that bulky spraying equipment and large amounts of water are transported to or available at the site of application. Further, there is typically a significant amount of clean-up required after hydromulching. Additionally, such spray application techniques may not be cost effective for use in small surface areas. The installation of sod is another method for establishing lawns or larger areas of turf. Sod is heavy and has a relatively short storage life. These factors increase the difficulty and cost of sod installation.

The present invention provides dried compositions in the form of sheets or rolled sheets (seed mats) for application to land surfaces, e.g., soil, prepared soil or unprepared ground, to establish vegetation which provides the benefits of use of hydromulch or hydroseeding techniques in landscaping and revegetation applications, but does not require the on-site use of spraying equipment and avoids excess labor requirements for after-spray clean-up. The top fibrous layer of certain embodiments of the seed mat can provide the benefits of straw or hay that is often used as a separate protective cover over an area that has been sprayed with hydromulch. The dried composition of this invention can be employed as an alternative to sod for any commercial or residential turf creation. The dried composition has generally longer shelf-life and is significantly lighter in weight than sod. Thus the dried composition is much easier to transport and install compared to sod installation and as a consequence is, in general, less labor intensive and expensive to install. Furthermore, the dried composition of this invention can be formed in sheets of varying sizes to accommodate applications to land surfaces of different sizes including relatively small areas. The seed mats herein can for example, be provided in the form of kits containing cut sheets of pre-selected sizes for lawn repair kits, flower bed kits and the like.

The seed mats of this invention exhibit increased resistance to runoff and do not require the use of staples or any protective overlayer to minimize or prevent wind damage to the mats.

Dried composition containing viable seeds can be placed in contact with soil, e.g., a land surface, where after contact with water, the seeds therein germinate to provide vegetation in the soil, e.g., on the land surface. Preferably the dried composition is in the form of sheets which may be pre-cut to a desired size and shape for application or in the form of a rolled sheet which can be unrolled, optionally cut to a desired shape, and applied to soil. The dried composition can be manufactured at a location remote from the site of application, optionally packaged and transported to the site of application. The dried composition may be pre-cut into sheets of any desired shape or size, preferably to facilitate handling and application.

The dried composition can, for example, be employed to establish turf by inclusion of selected turf grass seed in the dried composition. Representative uses of the dried composition include commercial or residential landscaping, and golf course development. In such application, the dried composition of this invention has significant advantage over the use of sod because it is much lighter in weight and more easily applied. Additionally, the dried composition may be provided in relatively small sheets (up to 1-3 feet) in length or width for lawn repair or to establish flower beds.

Most generally, the dried composition of the invention is formed from a mulch composition to which viable seeds and preferably fertilizer have been added, and to which water is added to form a suspension, slurry or paste. The amount of water added to the mulch composition is adjusted to provide the desired consistency of the material for formation of a sheet or a multiple layer sheet.

The mulch composition can be in the form of a hydromulch which is sprayed or otherwise formed into a layer, dried to remove water, and cut into desired sizes, or rolled into rolled sheets. In specific embodiments, the dried composition of this invention is formed as a layered composition having a fibrous layer coated with a mulch layer which contains viable seeds. Such a layered dried composition can, for example, by formed by spraying a mulch composition containing viable seeds onto a fibrous layer and thereafter drying the layered composition. The hydromulch composition contains sufficient water to facilitate spraying for ease of manufacture. In one embodiment, a seed mat is formed by spraying more than one sub-layers of hydromulch onto a layer of fibrous material such as hay, straw or shredded wood. It is preferred that multiple sub-layers of hydromulch are applied to form the mulch layer and that each sub-layer is at least partially dried before application of another sub-layer. Each sprayed sub-layer may contain the same mulch, seed and optional fertilizer composition or sprayed sub-layers may have different compositions. For example, a mulch layer may have mulch sub-layers containing no seed, seed, fertilizer or a mixture of seed and fertilizer. In a specific embodiment, a first sub-layer of mulch with no seed can be applied, followed by an internal mulch sub-layer containing seed and optional fertilizer, followed by a third mulch sub-layer containing fertilizer. In general, any commercial hydromulch composition that is appropriate for use at the site of application can be employed to form the mulch layer by spray application.

The mulch composition can be in the form of a mulch slurry or paste which is formed into a layer, dried to remove water, and cut into desired sizes, or rolled into rolled sheets. In a specific embodiment, a mulch slurry or paste containing viable seeds is poured, spread or otherwise applied onto a fibrous layer (e.g., hay, straw or shredded wood) to form a mulch layer. The mulch layer is optionally rolled to facilitate binding of the fibrous layer with the mulch layer and/or to force some of the water out of the material prior to drying. The mulch slurry or paste may be applied in multiple sub-layers where each sub-layer is at least partially dried prior to application of the next sub-layer. Each sub-layer applied may contain the same mulch, seed and optional fertilizer composition or sub-layers may have different compositions. For example, a mulch layer may have mulch sub-layers containing no seed, seed, fertilizer or a mixture of seed and fertilizer. In a specific embodiment, a first sub-layer of mulch with no seed can be applied, followed by an internal mulch sub-layer containing seed and optional fertilizer, followed by a third mulch sub-layer containing fertilizer.

Viable seeds can be added to the mulch layer as described above. Alternatively, viable seeds can be sprayed (in a water composition) or dispersed in a separate operation onto a sub-layer of mulch. This separate seed deposition may be followed by one or more applications of hydromulch or mulch slurry or paste to the layered composition being formed.

When present, the fibrous layer of hay, straw, shredded wood or they like, is the top layer of the seed mat. The seed mat is installed such that the dried mulch layer is in contact with the ground or soil and the fibrous top layer faces upward. The fibrous layer of the seed mat functions like a layer of hay or straw that is sometimes applied after direct hydromulching or hydroseeding applications to protect the mulch layer, the seeds therein, and the seedlings or shots that will germinate and grow therefrom. The fibrous layer also provides for retention of moisture in the mat after installation.

The mulch layers function to hold seeds and optional fertilizer of other germination or plant growth additives and provide an environment for seed germination and growth of seedling.

In one specific embodiment, the fibrous layer is fibrous plant matter, such as hay, straw, wood fiber, dried grass or combinations thereof. The fibrous plant material preferably dried prior to use in the fibrous layer.

In a specific embodiment, the mulch layer or coating spray comprises a mixture of paper and clay which can be provided by use of magazine stock (alternatively other shiny or glossy paper may be employed). Most generally, clay is present in the mulch composition in an amount ranging from about 1% to about 75% by weight of the total weight of paper and clay in the mulch. The amount of clay can be increased in the mulch composition to increase the mechanical strength of the seed mat. In addition to or instead of paper, other fibrous materials can be employed to form the mulch. For example, a mulch can be formed from corn husks in optional combination with corn silk, flax alone or in combination with paper (including magazine stock), sugar cane leaves alone or in combination with paper (including magazine stock).

A mulch suspension, slurry or paste can also be formed employing any commercially available mulch composition suitable for hydromulching applications by varying the amount of water added to obtain the consistency desired for the mode of application to form the mulch layer or sub-layer. Clay may be added to such commercial mulches to increase the mechanical strength of the seed mat.

Alternatively, the mulch can be newsprint or other paper (or cardboard) to which clay is added. The mulch layer comprises clay in an amount ranging from about 1% to about 75% by weight of the total weight of paper and clay in the mulch. Preferably, clay is present in the mulch in an amount ranging from about 10% to about 60% by weight of the total weight of paper and clay. Clay can be present in the mulch in an amount ranging from 20% to about 60% by weight of the total weight of paper and clay. Clay can be present in the mulch in an amount ranging from about 40% to about 60% by weight of the total weight of paper and clay. Clay added to the mulch layer is preferably clay of the kaolin clay group which contains a relatively high amount of kaolinite. Clay employed in the mulch layer preferably has relatively small particle size such as is employed in the coating of paper for use in magazine stock and other shiny or glossy paper. As noted above, mulch comprising clay and paper may also contain added plant fiber, such as hay, straw, shredded wood, flax, leaves or stalk. Materials added to mulch or used to form mulch are chopped or shredded to obtain desired consistency.

In an alternative embodiment, the dried composition may be formed by adding fibrous material (chopped hay, straw or shredded wood) to a hydromulch composition (i.e., a mulch composition containing sufficient water to allow spray application) or by adding such fibrous material to a mulch slurry or paste. The mulch composition with added fibrous material is then forming into a mulch layer by spraying, or spreading. Again the layer may be formed by formation of multiple sub-layers as described above. The layer is formed into a sheet and dried to obtain the dried composition of this invention. Viable seeds would preferably be contained in the mulch composition. Addition of fibrous material to a sprayable hydromulch composition may form a composition of sufficient solids content that spraying is inconvenient. In such a case, the wet composition can be formed into a sheet of desired thickness by conventional methods and dried to form the dried composition of this invention. In this embodiment, the mulch layer may be applied to a layer of fibrous material so that the seed mat has a top fibrous layer.

In a specific embodiment, the dried composition of the invention (seed mat) comprises a layer of fibrous plant matter and a mulch layer in contact with the layer of fibrous plant matter wherein the mulch layer comprises a mixture of paper and clay and contains seeds. The layer of fibrous plant matter comprises grass, hay, straw, wood fiber or combinations thereof. The fibrous plant matter is preferably dried. The fibrous plant matter layer preferably comprises grasses and, more preferably, comprises native grasses from the locality where the mat is to be used.

In a specific embodiment, the fibrous plant matter layer (top layer of seed mat) is formed by blowing a layer of plant matter in which the length of a majority (50% by weight or more) of the plant matter is 12 inches or less. In another specific embodiment, the fibrous plant matter layer is formed by blowing a layer of plant matter in which the length of the plant matter is six inches or less. Preferably the fibrous layer is blown employing a hay blower. Preferably the layer forms a mat in which fibers are randomly arrayed as is achieved by blowing cut pieces of the fibrous material into a layer. The fibrous plant matter layer may also be formed by generally aligning the fibers of the fibrous matter. The layer may be formed by selectively organizing the fibers of the fibrous matter into a pattern, e.g., a cross-hatched layer. Preferably, pieces of fibrous plant matter are randomly arrayed with respect to each other in the layer. The fibrous layer may be rolled after blowing. The layer may be formed on a removable substrate (a sheet of plastic) or on the ground. Preferably the fibrous matter layer is formed on a smooth, flat, level surface or on a prepared area of ground. If the fibrous matter layer is formed on a substrate sheet, e.g. a plastic sheet for example, it is preferred that, the substrate layer can be removed when desired without damage to the mat.

Hay, straw, dried grass or shredded wood or mixtures thereof may be employed as the fibrous layer. A preferred fibrous plant matter useful for the top layer of the seed mat is native grass. Native grass can be obtained from various sources. For example, the native grass can be harvested, dried if desired, cut to desired lengths and blown into a layer.

In a preferred embodiment, the layer of fibrous plant matter is formed by blowing a layer of fibrous plant matter on to a relatively flat surface (e.g., the ground). The fibrous plant matter forming the layer is preferably chopped or cut into pieces having length less than about 12 inches and, more preferably, into pieces that are less than about six inches in length. The fibrous plant matter can be predominantly (more than 75% by volume) composed of pieces that are between about ¼ inch and about six inches. The fibrous plant matter can be composed substantially of all of pieces that are less than about six inches in length.

The fibrous plant matter layer may be formed by generally aligning the fibers lengthwise of the fibrous matter. A portion of the entire layer may contain such alignment. For example, the alignment of fibers may form a cross-hatched pattern. In a preferred embodiment, the fibers of the fibrous plant matter are randomly arrayed in the layer. Dependent upon the application, the thickness of the mat can range from about ¼ inch to about 6 inches. More typically for landscaping applications the thickness ranges from about 0.5 inch to 2 inches. Reclaimation applications will generally require thicker mats or multiple layers of mats. Preferably, the fibrous plant matter layer formed is porous to water, but is sufficiently dense to provide protection for seeds in the mat or seedlings germinating or growing in the mat. The application of the mulch layer to the fibrous material layer can provide sufficient mechanical strength to the layered seed mat material such that the mat may be rolled onto spindles for transport to application sites or cut into sheets of desired dimensions for easy in application. If additional mechanical strength is needed or desired in the seed mats, the fibrous matter layer can be reinforced using lengths of string (laid parallel to each other in one or two directions across the layer) or a two-dimensional net of string laid over the fibrous plant matter prior to application of the mulch layer.

In a specific embodiment, the grass mat is formed by first providing a layer of fibrous plant matter and thereafter applying a mulch comprising paper and clay and containing seeds to the layer of fibrous plant matter. In a specific embodiment, the fibrous plant matter is formed by chopping and blowing a layer of native grass. In a specific embodiment, the mulch layer is provided as a sprayable hydromulch layer. In a more specific embodiment, the mulch layer contains chopped magazine stock.

The mulch layer is formed or applied to the fibrous matter layer and the layers or combined layers formed provide sufficient mechanical strength after drying to allow the resulting seed mat to be rolled onto a roller or to be cut into convenient size sheets for transport to the application site or for packaging for sale. The seed mats typically range in thickness from 0.25 inch up to about 2 inches. Preferably the seed mats range in thickness from about 0.5 inch to about 1.5 inches. More preferably the seed mats range in thickness from about 0.5 to 1 inch. The thickness of the seed mat and the clay content of the mulch can be adjusted to provide for sufficient mechanical strength in the seed mat. After drying, the seed mat should preferably exhibit sufficient mechanical strength as a sheet that can be cut to size and packaged without breaking or crumbling.

Seed mats of this invention do not require the use or presence of an adhesive layer to attach seed. Seed are contained and held within the mulch layer. Clay which may be provided simply in magazine stock is believed to function as a binding agent for the mulch and fibrous material in the seed mat.

Seed mats of this invention can contain any desired seed that can be grown in the area in which the seed mat is to be employed. The seed mat may contain grass seed (including native grass seed), grain seed (e.g., barley), wild flower seed, or seeds of various annual and perennial plants, flowers and shrubs. The seed mats of the invention can be employed in landscaping applications.

This invention also relates to seed mats as described herein and methods of using them for revegetation and remediation of land that is barren or sparsely vegetated, rocky, eroded and/or having little or no top soil. In land remediation applications compared to landscaping applications, it is preferred to employ significantly higher levels of seed in the seed mats. Seed can be incorporated into the seed mat at a level of that would provide from about 30 to 400 lbs of seed/acre. The amount employed depends on the type of seed and the state of the land to be landscaped or revegetated. In land remediation applications, seed in the mat is preferably selected to include native grass seed and grain seed, particularly barley seed. The methods and materials of the invention are particularly well-suited, for example, to areas that have been subjected to strip mining or to areas containing mine tailings. The materials and methods of the invention are also useful in the regeneration of overgrazed areas. The methods and materials of this invention are further useful in areas where vegetation has been detrimentally impacted by industrial activity, the release or accumulation of toxic materials (e.g., heavy metals, i.e. uranium tailings), oil spills, chemical spills and the like.

For most revegetation/remediation applications at least 100 lbs of total seed/acre should be applied. Preferred total seeding rates are 150 or more lbs/acre and more preferred seeding rates are 200-400 lbs/acre. Seeding rates greater than 400 lbs/acre may be employed, but are generally not preferred due to increased cost. High seeding rates are employed to facilitate the creation of a layer of plant material, including dead plant material, on the land surface to create a “biological event” to provide an improved environment for growth of surviving plants, seeds in later seed applications, seeds in the area prior to seeding and/or adventitious seeds which enter the treated land after initial seeding.

For use in land restoration and revegetation, the mat preferably comprises seed of one or more grains or one or more native grasses. Preferred grains for inclusion in the initial application(s) are barley, oats, rye and mixtures thereof. The more preferred grain for initial applications is barley which achieves the most rapid development of plant surface coverage. Native grasses are selected for use in the location being revegetated. Preferably native grasses that exhibit rapid growth in the location are preferred. In a specific embodiment, the seed mat comprises a mixture of grain seed and native grass seed. The seed mixture may also include wild flower seed selected as appropriate for the location. Blue Flax, Mexican Hat, and Prairie Cone Flower are suitable wild flower seeds for inclusion in seed mixtures for use in the Southwestern United States. Wild flower mixtures appropriate for use n various locations are commercially available. Information concerning wild flower seed appropriate for use in a given location is readily available in the art.

In a specific embodiment for revegetation applications, the seeding mixture in the mat comprises a predominate (50% or more by weight) native grass seed selected for rapid growth in the region being treated. More preferred seed mixtures are those which contain a predominant native grass seed in combination with minor amounts of a variety of other native grass seeds. For applications in the U.S. southwest, an exemplary predominate native grass is Blue Grama which is tolerant to drought, high winds and arid climate. Useful seed mixtures include those in which 50% or more by weight of Blue Grama seed are combined with seed of one or more native grasses including Sideoats Grama, Little Bluestem, or Galetta. Information is readily available in the art concerning native grasses suitable for use in various locations and climates. Wild flower seed may be incorporated into seeding mixtures, typically in relatively minor amounts (1-25% by weight).

In specific embodiments for revegetation applications, the initial seeding mixture in the mat contains more than 50% by weight of grain seed. The application seed mixture can contain from about 80% to 100% grain seed. In a specific example, the application seed mixture contains less than 50% by weight of native grass seed. In other specific examples, the application seed mixture contains from about 5-20% by weight of native grass seed and from about 80-95% by weight of grain seed. In other specific examples, the application seed contains from about 5-20% by weight of native grass seed and from about 80-95% by weight of barley.

In other specific embodiments for revegetation, the seeding mixture in the mat contains from about 80% to 100% of a predominant native grass seed (e.g., Blue Gamma seed). In a specific example, the seed mixture contains less than about 20% by weight of native grass seed other than the predominant native grass seed. In other specific examples, the seed mixture contains from about 5-20% by weight of native grass seed other than the predominant native grass seed. In other specific examples, the seed contains from about 75%-95% by weight of the predominant native grass seed, from about 1% to about 20% by weight of wild flower seed with the balance of the mixture being native grass seed other than the predominant native grass seed.

The seeding mixture in the mat may also contain seeds of pioneer plants, shrubs and trees (i.e., pioneer seeds) appropriate for the location that is to be revegetated and/or remediated. The term pioneer is applied to plants (including trees and shrubs) which are capable of invading sites lacking vegetation, such as newly exposed soil and persisting there until supplanted by succeeding species. For example, pioneer plants are the first plants to grow in an area after a major disturbance of vegetation through fire, harvest or the like. In general, the seed mixture in the mat will contain only a minor component of such pioneer seed.

Optionally, particularly in a revegetation project, seeds, seedlings or more mature plants, shrubs and trees (including pioneer plants) can be introduced or planted in the treated area once the desired coverage of grass and/or grain is achieved from the seed mats.

In another specific embodiment, particularly applicable to land that has been overgrazed, seeds of cash crops can be included in the seeding mixture in the seed mat or seedlings of such crops can be planted in the treated area after initial seed mat application. Exemplary cash crops which could be established using the methods herein include hardwoods, such as black walnut, ash, birch, cherry, oak and poplar, among others.

Mulch employed in this invention can optionally contain organic and inorganic. materials in addition to paper, fiber and clay. The mulch is preferably biodegradable. Mulch can further comprise shredded wood or bark, leaves, leaf mold or the like. Exemplary mulches include paper products, hay, straw, cut native grass and mixtures thereof. Mulch is selected as appropriate for the land surface to be treated to generally remain in place were applied, as appropriate for the means employed for applying the initial seed applications and in general to minimize cost.

Mulch provides a substrate for retaining nutrients and waters and protection for seeds, sprouts and seedlings during initial applications and during initial seedling development. Addition or inclusion of clay in the mulch facilitates adhesion of mulch. Mulch can also provide a suitable environment for the development of microbial floral beneficial for the growth of selected plants, shrubs or trees.

The mulch layer of the seed mat may optionally comprise nutrients including a nitrogen source, a phosphorous source, and humates, particularly humates containing fulvic acid. Nitrogen and/or phosphorous can be provided through use of a commercial fertilizer. Commercial fertilizers are also available that provide humates in addition to nitrogen and/or phosphorous. Additional plant nutrients, including among others, amino acids, trace minerals, and/or selected metal ions can also be added to the mulch composition. Sources of nitrogen, phosphorous, humates, amino acids, trace minerals and or other metal ions appropriate for use in application to soil for growth of plants or to plants are known in the art. Selected metal ions may be particularly beneficial, if the land to be revegetated is found to be deficient in a beneficial metal. The concentrations of nitrogen, phosphorous and humates in formulations herein are adjusted to avoid levels detrimental to plant growth. The concentration of any metal ions in formulations herein is adjusted to avoid levels of metals detrimental to plant growth. In a specific embodiment, the seed mat can be manufactured to contain nutrients or a combination of nutrients selected based on soil analysis or through the analysis of plants existing at the site to which the mats are to be applied to be compatible with existing soil conditions or to supplement soil deficiencies. A preferred fertilizer for addition to mulch layers is a chicken/fish emulsion.

Compositions which facilitate or enhance seed germination which are known in the art may be added to the mulch layer of the seed mat.

The mulch layer may also contain humectants to facilitate water retention for plant growth. Suitable humectants are described in U.S. Pat. Nos. 5,865,869 and 5,814,123 and are commercially available (Ecologel, Ocala, Fla.).

Plant nutrients, fertilizers, and other additives noted above are optionally added to the mulch layer of the seed mats herein in an amount that is beneficial for germination and growth of the seeds in the mat. The type and amount of such additives that are included depends upon the type of seeds in the mat and the environment into which the seed mats are installed. Plant nutrients, fertilizer and other additives may be added to or supplemented in the seed mat after installation on the land surface.

The invention provides kits comprising one or more seed mats of this invention in combination with instructions for installation, use and or after-care. The kits may also include fertilizers, plant nutrients or other compositions for application to the seed mat on installation or during aftercare. Liquid or solid plant nutrients, fertilizers and like additives can be included in kits and are preferably included in the kits in individual labeled containers in pre-weighed amounts with instructions for use.

The invention provides a method for growing plants, particularly grass and turf, which comprises providing a seed mat of this invention in contact with the ground or soil in the area where the plants are to be grown. The seed mat is applied to the land mulch-side down. The fibrous plant matter layer, if present, provides protection for the mulch and seeds therein. Water and nutrients are optionally, but preferably, applied to the seed mats to initiate germination of seeds and growth of plants. After-care as described below is preferably employed after initial installation of the seed mats. Note that during installation pre-cut seed mats can be further shaped by cutting.

The land surface to which the seed mats are to be applied is optionally furrowed or scored prior to application. The land to which the seed mats are to be applied may be graded prior to treatment. Artificial Irrigation, through use of an irrigation system (drip or spray) or by mechanical or manual spraying or drip application of water, can be combined with the steps of this method as appropriate for the location. Alternatively, natural sources of water and nutrients can be used without supplementation.

Optional after-care includes periodic application to the seed mats of one or more growth stimulating compositions and periodic application to the seed mats of a growth maintenance composition. The growth stimulating compositions comprise selected nutrients and plant growth factors. The growth maintenance composition comprises nitrogen and optionally comprises other selected nutrients, but containing no plant growth factors. After-care applications of growth stimulating and growth maintenance compositions are repeated on a generally alternating basis to achieve a desired level of growth. Preferably the periodic applications of growth stimulating compositions and growth maintenance compositions are made by foliar spraying. Growth stimulating after-care compositions are generally applied more frequently than growth maintenance after-care formulations which contain nitrogen. In specific preferred embodiments, growth maintenance after-care formulations are applied once for every 3 or 4 applications of growth stimulating after-care formulations. After-care formulation applications are performed as needed or desired to maintain and or enhance growth of initially seeded plants and may be continued after planting of any secondary plants, shrubs and/or trees. For example, growth maintenance formulations containing nitrogen may be applied when visual inspection of the treated area shows yellowing of the plants. Nitrogen-containing compositions are preferably not applied to the seed mats at the same time as growth stimulating formulations. After-care formulations can, for example, be applied on a weekly, biweekly, monthly, bimonthly, after initial seeding. More preferably after-care formulations are applied on a biweekly or monthly schedule.

After-care is typically applied for a time sufficient to ensure the development of stable vegetation from the seed mats. The length of time of after-care applications will depend upon the nature of the site, with rocky, eroded, contaminated areas or areas with little top soil generally requiring longer after care than areas which are sparsely vegetated and or overgrazed. Preferably aftercare is continued for at least one year and more preferably, dependent on soil conditions, for three or more years.

The continued application and application schedule for after-care formulations will depend at least in part on the climate with less frequent (or no) applications during winter months (dependent upon climate). Seed mats can be applied at any time of the year which will allow for germination and preferably seedling development. The seed composition employed in the seed mat can be adjusted to be more suitable for seeding during different seasons. For example, more cold hardly seed can be employed if seeding is performed during the colder seasons.

Generally, after-care begins within one to two weeks after the seed mats are applied. However, after-care can be delayed in certain circumstances. For example, if mats are laid in the late fall or winter, after-care may be delayed until seeds begin to germinate. It may be necessary or beneficial to adjust after-care schedules to changes in weather conditions, for example, after-care may be delayed due to heavy rains, snow, cold or other weather conditions. The frequency of after-care applications will generally be higher during the local growing season than during times of plant dormancy. Additionally, the frequency of after-care applications will depend generally upon the types of seeds employed in the seeding layer.

After-care compositions can also include humates, and nutrients including amino acids. Commercially available humate compositions including Humasol, a water-soluble Leonardite (Agricare, Inc, Amity Oreg.), and Humasolve (TM, Bioag Corporation, Honaunau, Hi.) can be employed in the mulch composition and in any after-care compositions that may be employed.

Fish emulsion and chicken and fish manure can be employed in the mulch compositions, or in any after-care compositions as a nitrogen source. These materials may also provide a food source for microorganism beneficial to plant growth. An exemplary, useful chicken and fish manure is available from Hallier Corp. (Vermillion, Kans.) under the tradename Bioform. Another useful nitrogen source is fish protein hydrolysate also available from Hallier Corp. under the tradename Bioform FPH 8-8-8. This material also contains seaweed extracts which are a source of trance minerals as well as plant growth factors (gibberellins).

The mulch layer and after-compositions herein can optionally include silicic acid. Humasolve (Bioag Corp.) is a commercial source of humates and silicic acid.

The mulch layer of the seed mat optionally includes plant growth factors such as gibberellins. Preferred plant growth regulators for use in the seed mats are one or more gibberellins. The seed mat may include one or more gibberellins or mixtures thereof. Gibberellins (designated individually as Gibberellin Ax, where x is an integer) are a group of diterpenoid acids that function as plant growth regulators. At least 126 gibberellins are known in the art. Gibberellins are available in various forms from commercial sources. Gibberellins can be provided from natural sources, such as seaweed, particularly kelp. Seaweed can also provide a source of trace minerals beneficial for plant growth.

Commercial products are generally employed in the mulch layer of the seed mat and in any after-care formulations herein in the amount or amounts recommended by the manufacturer except as otherwise noted.

Growth maintenance compositions comprise one or more nitrogen sources and optionally contain phosphorous, humates and a selection of plant nutrients. Growth maintenance compositions do not contain any significant amount of plant growth factors, such as gibberellins. Plant nutrients include among others one or more amino acids, one or more beneficial metal ions, and/or a mixture of trace metals.

Growth stimulating compositions comprise one or more plant growth factors, e.g., gibberellins and optionally comprise phosphorous, humates, and plant nutrients, such as amino acids. Gibberellins can be provided for example in seaweed extract.

The methods of this invention can be combined with inoculation with beneficial microorganism, particularly in the form of inoculants. Inoculants may contain a selected type of beneficial organism (e.g., fungus or bacteria) or a beneficial mixture of microorganism. Inoculants typically contain, live or dormant microorganisms (e.g., living cells, spores, etc.) in a selected carrier which may be inert or which provides a food and or nutrient source for the microorganism. Inoculants may contain a single type or species of microorganism or may contain a mixture of two or more microorganisms. Inoculants are selected for a given application as is known in the art. Further, microorganisms may be selected by art-known enrichment methods for a given application. Inoculants may be selected as beneficial for plant growth (e.g., for providing a growth stimulator or for providing a needed element, such as nitrogen). In applications to remediation where there is an undesired level of a pollutant or contaminant, such as oil or chemicals, inoculants can be selected based on the ability of the organisms therein to degrade or facilitate the degradation of the oil or chemical. Inoculants may be combined in one or more of the initial seeding applications. Inoculants may be applied after the seed mat layer is applied, to the layer of growing grasses/grains anytime thereafter or when additional plants, seedlings or trees are planted in the landscaped or revegetating area.

A stable inoculant may be included in the mulch layer of the seed mat to provide benefit to plants grown from the seed mat The mulch layer of the seed mat may also be provided with selected microbial nutrients to enhance selective growth of desired microbial flora.

An exemplary beneficial innoculum for use in seeding and after-care compositions is a micorrhizal innoculum, such as those available from Reforestation Technologies International (Salinas, Calif.). Micorrhizal innoculum is beneficially combined with silicic acid.

Aftercare applications can be employed to achieving more rapid stable plant growth and are particularly beneficial for revegetation applications. Aftercare applications of growth stimulation compositions and growth maintenance compositions are continued as long as desired or practical and preferably until stable vegetation or revegetation is achieved in the area where the seed mats have been applied. Stable vegetation or revegetation includes the establishment of vigorous ground cover of desired plants grains, native grasses, and/or shrubs and/or trees at coverage levels appropriate for the terrain and climatic conditions that has a high likelihood of maintaining its growth level over time without further treatment.

The methods of this invention can be combined with plant treatment methods which employ the application of high frequency sound waves as described in U.S. Pat. Nos. 4,680,889; 4,834,789; 5,043,009 of Carlson or as provided in commercially available products by Carlson or others under the tradename Sonic Bloom™. Each of these three U.S. patents are incorporated by reference herein for a description of these plant treatment methods and means for subjecting plants to sound waves of appropriate frequency. Products available under the tradename Sonic Bloom™ are useful in the seeding compositions and after-care compositions herein and do not require the use of sound waves to provide beneficial effect. Application of such compositions alone or preferably in combination with methods for application of sound waves and in combination with the methods herein are found to generally provide increased growth rate of plants and increased generation of biomass to support revegetation and remediation. Plant growth stimulating compositions and plant growth maintenance compositions herein can be applied as described in the patents or in Sonic Bloom™ product literature with accompanying exposure of plant to sound waves. Additional information about current methods of application of sound waves for plant growth enhancement can be found at the web site: www.sonicbloom.com. Product literature is also available from Dan Carlson Scientific Enterprises, Inc (River Falls, Wis.).

The mulch layer of the seed mat and after-care formulations can optionally include one or more biodynamic preparations. Nine biodynamic preparations were described by R. Steiner for enhancing soil quality and/or stimulating plant growth. In general, the formulations consist of mineral, plant, or animal manure extracts, usually fermented and applied in small amounts (highly diluted) to soil, or onto plants or to prepare compost for use in farming. Original biodynamic (BD) preparations are numbered 500-508. The BD 500 preparation (horn-manure) is employed as a soil spray to stimulate root growth and humus formation. The BD 501 preparation (horn-silica) is made from powdered quartz and applied as a foliar spray to stimulate and regulate growth. BD 502-507, is used in making compost and can be combined with BD 500 or BD 501 for application to soil and/or plants. BD 508 is prepared from the silica-rich horsetail plant (Equisetum arvense) and used as a foliar spray to suppress fungal diseases in plants. Biodynamic preparations are available from commercial sources or can be prepared by methods that are widely known in the art. One commercial source of biodynamic preparations is the Josephine Porter Institute (JPI, Woolwine, Va.). Dilutions for application of biodynamic preparations are prepared as known in the art and as described by commercial providers. In specific embodiments, initial seeding compositions can include one or more of BD 500-507 in an amount effective for use as described by commercial providers, such as JPI. In more specific embodiments, initial seeding compositions can include BD 500 and/or BD 501. In other specific embodiments, initial seeding compositions can comprise compost prepared using biodynamic preparations. Biodynamic preparations can also be applied as a part of after-care.

Biodynamic preparations or compost prepared using biodynamic preparation may be employed in the mulch layer herein or in after care applications. For example biodynamic compost may be applied to the land prior to application of seed mats, included in seed mats or applied after seed mats are laid. Biodynamic compositions prepared as indicated by the commercial supplier containing BD 500 and/or 501 can be sprayed on the seed matted area as an after-care step. Such applications would be at a level of about 2 gallons/acre. The frequency of application would be about 2-3 times in the growing season.

Exemplary after-care compositions include:

A first growth stimulating composition comprising gibberellins, amino acids and trace elements, such as provided in Sonic Bloom™ which can be used typically in amounts as recommended by the manufacturer for foliar sprays or at somewhat higher concentrations. This growth stimulation composition is the most frequently applied after-care composition. Typical applications are weekly or biweekly after seed mat application (application frequency may be decreased based on climate or other conditions as discussed above.) Applications may be increased or decreased in frequency based on visual observation of the status of the growth in the treated area.

A second growth stimulating composition comprising Humisolve Ion 14 (in recommended amounts) and a micorrhyzal innoculum in recommended amounts. This composition is less frequently applied and typically is applied on once a month or several times during the growing season. This composition may be applied in place of, or in combination with, the first growth stimulating composition.

A growth maintenance composition comprising a nitrogen source, e.g. as provided by fish emulsion, chicken/fish manure or the like. The composition may also contain nutrients (e.g., amino acids, phosphorous, trance elements, metal ions), but does not include any significant amount of plant growth factors. The concentration of nitrogen source in the composition is as recommended by the manufacturer for foliar applications. However care must be taken in application to avoid application of detrimentally high amounts of nitrogen. This composition is the least frequently applied after-care composition and is typically applied once for every three to four applications of the first and/or second growth stimulating composition. However, this composition may alternatively be applied only when visual inspection detects yellowing of the plants indicative of the need for nitrogen application.

In preferred embodiments, after-care compositions for foliar application by foliar spraying are pH balanced between pH 6-8. Foliar application of growth stimulating and growth maintenance compositions for after-care is done at a level between about 25-50 gallons/acre, but is adjusted so that the spray applied coats foliage, but avoid dripping.

### THE EXAMPLES

An exemplary seed mat is prepared as follows:

Dried native grass or hay is introduced into a hay blower and blown over about 1 acre of flat ground. About 1,000-2000 lbs of dried grass or hay is applied in this blowing process. A hydromulch for spraying onto the fibrous layer is prepared by combining 8-10 bales (50 lbs each) of magazine stock (particularly magazine stock comprising 60% by weight clay), and 12-20 lbs of seed in a hopper with 1,200 gallons of water.

The hydromulch composition is sprayed uniformly over the blown layer of grass. until a mulch layer between 1-2 inches is obtained. This thickness is typically that used for turf growth in a sports field. For reclaimation application thicker seed mats up to about 4 inches thick are preferred. The layer thickness will decrease on drying. Spray application may require 8-10 batches of the hydromulch. The mulch/fibrous mat is allowed to dry in a low humidity atmosphere (as available in the Southwestern United States in the summer). Once dry the mat has sufficient mechanical strength to be rolled onto one or more rollers or cut into sheets for application. Further, the mats should be dried within about 1-2 days after making to avoid germination of the seed in the mat.

Another exemplary seed mat is prepared as follows:

A mulch composition is formed by adding water to a mixture containing 4,000-5,000 lbs of mixed shredded wood and paper, 50-500 lbs of added clay (red pottery clay, for example), 2-3 gallons of liquid fertilizer, 200-500 lbs dried chicken/fish emulsion, 24 ounces of a liquid microbial inoculant and 150-200 lbs of grass seed (native or turf). A mulch layer is formed by spraying the mulch or preferably by forming a mulch slurry or paste into a layer. Sufficient water is added to the mulch composition to obtain the consistency needed for the form of application. More water is generally needed to facilitate spray application. The mulch layer can be formed in multiple sub-layers where each sub-layer is allowed to dry prior to application of the next sub-layer. The wet mulch layer may be rolled or pressed prior to drying to facilitate better adhesion of the materials in the mulch layer and/or to facilitate water removal. The Layered material is dried and cut into sheets or rolled sheets. The material may be simply left in the a dry, sunny location to dry, may be air dried using fans or blowers, may be dried by application of heat or may be dried by insertion into an oven. Drying temperatures should be controlled so that seeds and microbial inoculant are not damaged. The sheets or rolled sheets of dried materials are packaged preferably to prevent exposure to water and in general to minimize exposure to moisture.

Seed mats can of course be prepared on a smaller scale employing the same relative proportions of ingredients.

It will be appreciated by those of ordinary skill in the art that a seed mat as described herein can be prepared using a variety of different manufacturing methods. A fibrous material layer may be prepared on various supports or on a conveyor belt The supported fibrous material layer can be sprayed with hydromulch or a mulch slurry can be applied to the fibrous material layer using various methods. For example, a supported fibrous layer may be transported on a conveyor belt under sprayers which apply the mulch layer. After the mulch layer is applied the supported seed mat can be passed into a low humidity area, passed into an oven or passed under heaters for drying.

When a Markush group or other grouping is used herein, all individual members of the group and all combinations and subcombinations possible of the group are intended to be individually included in the disclosure. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given, are intended to be included in the disclosure.

All patents and publications mentioned in the specification are indicative of the levels of skill of those skilled in the art to which the invention pertains. References cited herein are incorporated by reference herein in their entirety to indicate the state of the art as of their filing date and it is intended that this information can be employed herein, if needed, to exclude specific embodiments that are in the prior art from the claims. For example, when a compositions is claimed, it should be understood that compositions known in the art including the compositions disclosed in the references disclosed herein are not intended to be included in the claim. The prior art described herein contains compositions containing various components any one or more of which can be excluded from the compositions herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein where any one of the terms “comprising”, “consisting essentially of” and “consisting of” is used that term may be replaced with either of the other two terms. When a composition or apparatus is described as comprising one or more elements, it is also intended that compositions or apparatus which consist essentially of the listed components, as well as compositions or apparatus which consist of the listed components are encompassed by the invention.

The invention illustratively described herein suitably may be practiced in the absence of any element or elements, limitation or limitations which is not specifically disclosed herein.

Those of ordinary skill in the art will appreciate that materials (e.g., nitrogen sources, gibberellin sources, nutrient sources, innoculum, etc.) and methods (e.g., application methods) other than those specifically exemplified herein can be applied to the practice of this invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

All references cited herein are incorporated by reference herein in their entirety. Some references provided herein are incorporated by reference to provide details concerning alternative or additional materials that can be useful in the practice of the invention or sources of such materials.

I claim:

1. A seed mat which is a dried composition in the form of a sheet or a rolled sheet that contains one or more layers wherein at least one layer contains fibrous material and at least one layer contains mulch and viable seeds.

2. The seed mat of claim 1 which comprises a fibrous layer of plant material, and a layer of dried mulch containing viable seed wherein the mulch comprises clay.

3. The seed mat of claim 1 wherein the mulch comprises magazine stock.

4. The seed mat of claim 1 wherein the mulch comprises a combination of clay and newsprint.

5. The seed mat of claim 1 wherein the mulch comprises paper or a combination of paper with fibrous material.

6. The seed mat of claim 2 wherein the fibrous layer comprises dried grass, hay, straw, shredded wood or mixtures thereof.

7. The seed mat of claim 1 wherein the seed mat contains at least about 1 lbs of seed/square foot.

8. The seed mat of claim 7 where the seed of the seed mat comprises native grass seed or grain seed.

9. The seed mat of claim 1 wherein the mulch layer is composed of two or more layers.

10. The seed mat of claim 1 which is formed by spraying a hydromulch onto a layer of the fibrous material and drying the layer formed.

11. The seed mat of claim 10 wherein the mulch layer is formed from a plurality of sprayed sub-layers.

12. The seed mat of claim 1 which is formed by forming a mulch layer from a mulch slurry or paste and drying the layer formed.

13. The seed mat of claim 1 wherein the mulch layer is formed from a plurality of sub-layers.

14. The seed mat of claim 1 further comprising one or more of a fertilizer, a plant nutrient, a humate, or a humectant in an amount beneficial for growth of seeds in the mat.

15. A method for growing plants on a selected area of ground which comprises application of one or more seed mats of claim 1 to the selected area wherein the mulch layer is in contact with the ground or soil of the area.

16. The method of claim 14 which further comprises application of after-care steps as described herein above to the seed mats.

17. A kit for establishing vegetation on a selected land surface which comprises one or more seed mats of claim 1 pre-cut to have a selected size and shape and packages to minimize exposure to moisture.

18. The kit of claim 16 further comprising instructions for installation, use and or after-care of the seed mats.

19. The kit of claim 17 wherein the seed mat comprises flower seed or grass seed.

20. The kit of claim 19 further comprising in one or more containers pre-measured amounts of one or more of liquid or solid fertilizer or one or more plant nutrients.
